(19) United States
(12) Patent Application Publication
(10) Pub. No.: US 2012/0166203 A1
(43) Pub. Date: Jun. 28, 2012

(54) System and Method for Mobile Workflow Processing

(75) Inventors: Ztiki Kurland Fuchs, Bnei Dror (IL); Eliran Polak, Haifa (IL); Erez Kaplan Haelion, Rehovot (IL)

(73) Assignee: BIO-NEXUS LTD., Netanya (IL)

(21) Appl. No.: 13/329,654

(22) Filed: Dec. 19, 2011

Related U.S. Application Data
(60) Provisional application No. 61/540,180, filed on Sep. 28, 2011.
(60) Provisional application No. 61/424,688, filed on Dec. 20, 2010.

(51) Int. Cl. G10L 11/00

(52) U.S. Cl. 704/275; 704/E11.001

(57) ABSTRACT

A system and method of wirelessly serving a work flow protocol to agents for use with respect to subjects. The agents wear headsets, each with a display and a microphone coupled to a portable controller. The work flow protocol causing presentation of queries through the headsets based on a logical tree structure. Data generated by speech of the agents is received and stored.

### PRIORITY CLAIM

The present application claims priority from U.S. Provisional Patent Applications Ser. No. 61/424,688, filed Dec. 20, 2010 and Ser. No. 61/540,180, filed Sep. 28, 2011. All of the foregoing applications are hereby incorporated herein by reference in their entirety.

### TECHNICAL FIELD

The present invention relates to workflow processing systems and methods, and more particularly to methods and systems for administering a workflow protocol, including for use by medical providers with respect to patients.

### BACKGROUND ART

Data collection and processing from numerous mobile input sites can be a challenge. Circumstances can make keyboard entry or touch screen entry cumbersome. For example, a mechanic analyzing a motor vehicle may not be in a position to make such manual entries nor to hold and review the mobile screen. Other environments can be likewise challenging with regard to mobile data entry.

During an emergency, such as war, ongoing medical crisis, or terror attack, medical personnel are deployed throughout and around the scene. The highest priority of the medical personnel is to evacuate the patient and injured to hospitals or other large medical facilities as quickly as possible.

When a situation arises involving a number of injured people, the conduct and coordination of the medical personnel are subject to confusion, especially with respect to evacuation priorities, which treatments were given, and the course of action that is needed for each individual. This confusion dramatically affects the quality of the treatment that is being delivered to the patients. Additionally, because of the stressful situation, the patients' reports regarding the treatment are not correctly written, if at all. When an injured individual or patient reaches the hospital without the medical report or medication that was given to him, and/or without the history of their vital signs, a situation may arise where the quality of treatment that the hospital provides is dramatically degraded, and can even be life threatening.

As a direct result of the lack of reports and the natural chaos that ensues during an emergency situation, the amount of permanent damage and morbidity is greatly increased.

### SUMMARY OF THE EMBODIMENTS

In accordance with one embodiment of the present invention there is provided a method of administering a work flow protocol, with respect to a subject, carried out by an agent who is a natural person. The method of this embodiment includes wirelessly serving from a system coordinator server, to a portable controller carried by the agent, protocol data characterizing a logical tree structure for a series of queries configured to implement the protocol. The controller is in wireless communication over a network with the system coordinator server and is coupled to a headset worn by the agent. The headset includes a display and a microphone. The controller causes presentation of queries through the headset based on the logical tree structure. Queries may be audible through a speaker or visual on the display.

The method further includes receiving, over the network from the controller, subject data, concerning the subject, that was provided in speech by the agent spoken into the microphone, responsive to the displayed screens. Finally the method includes storing the subject data in system coordinator storage at the system coordinator server.

Optionally, the method further includes synchronizing subject data in the system coordinator storage with subject data that has been stored in a storage device associated locally with the controller. In a further related embodiment the speech has been recognized by the controller and the recognized speech has been stored as the subject data in the storage device.

Also optionally, the speech has been stored prior to recognition as the subject data in the storage device, and the method further includes recognizing the speech in the subject data after it has been received over the network from the controller and thereafter storing the recognized speech in the system coordinator storage.

In another related embodiment, the subject data is received in real time over the network from the controller in the form of speech prior to recognition, and the method further includes recognizing the speech in the subject data after it has been received and thereafter storing the recognized speech in the system coordinator storage.

In related embodiments, speech recognition is facilitated by having a restricted word set associated with any given ones of the queries. Words found in a word set of other queries are treated as background noise during speech recognition when the word set for the present query does not include those words. Commonly used words not found in a word set are advantageously treated as background noise during speech recognition.

Alternatively or in addition, other controllers are used by other agents and such other controllers are in wireless communication over the network with the system coordinator server, and the method further includes making the stored data available over the network, via the system coordinator server, to the other controllers.

Also alternatively or in addition, the method further includes using information stored in system coordinator storage to update information in a data repository. Optionally, the method further includes storing subject data in the system coordinator storage in real time and making such data available in real time to the other controllers. Also optionally, the method further includes using the subject data in the system coordinator storage to update the repository in real time.

In another related embodiment, the subject is a natural person receiving medical treatment. Alternatively, the subject is at least one of equipment and software being serviced.

In yet another related embodiment, the method further includes providing the subject with a machine readable tag and using the tag for identification of the subject in connection with the subject data.

In another related embodiment, the method further includes storing subject data in the system coordinator storage in real time, storing data received from the other controllers in the system coordinator storage in real time, and making data in the system coordinator storage available in real time to an event manager controller used by a supervisor of the agents.

In yet another related embodiment, the repository is in a central control center in communication with a plurality of system coordinator servers and obtaining data from each of the plurality of system coordinator servers. Optionally, the central control center is in communication with a data center for an enterprise and information from the repository is shared with the data center.

In another related embodiment, the data center stores patient data for one of a hospital and a network of hospitals.

In another related embodiment, the headset includes a camera, coupled to the controller, and configured to capture image data of the subject under control of the agent, the method further comprising receiving image data of the subject over the network from the controller and storing the image data in the system coordinator storage.

In yet another related embodiment, the method further includes receiving, over the network from a peripheral interface coupled to a measurement device in turn trained on the subject, quantitative measurement data concerning a parameter of the subject and storing the measurement data in the system coordinator storage.

Another related embodiment further includes receiving data packets corresponding to a barge-in communication from a supervisor in chief at the central control center and forwarding such data packets to the controller for presentation as a barge-in communication to the agent. Optionally, the packets include digitized voice data for being converted to audio by the controller and an earphone, worn by the agent, coupled to the controller. Optionally, the embodiment further includes passing data packets bi-directionally to facilitate two-way audio communication between the agent and the supervisor in chief.

Another embodiment provides a system for administering a work flow protocol, with respect to a subject, carried out by an agent who is a natural person. In this embodiment, the system includes a system coordinator server performing computer processes including those described in connection with any of the methods previously described. Thus in one embodiment, the processes include:
wirelessly serving, to a portable controller carried by the agent, protocol data characterizing a logical tree structure for a series of queries configured to implement the protocol, wherein the controller is in wireless communication over a network with the system coordinator server and is coupled to a headset worn by the agent, such headset including a display and a microphone, such controller causing presentation of queries through the headset based on the logical tree structure;
receiving, over the network from the controller, subject data, concerning the subject, that was provided in speech by the agent spoken into the microphone, responsive to the displayed screens; and
storing the subject data in system coordinator storage at the system coordinator server.

These processes may be supplemented and modified as described above.

### BRIEF DESCRIPTION OF THE DRAWINGS

The foregoing features of embodiments will be more readily understood by reference to the following detailed description, taken with reference to the accompanying drawings, in which:

FIG. 1 is a schematic illustration of a mobile workflow management system, constructed and operative in accordance with an embodiment of the present invention;

FIG. 2A is a perspective illustration of a visor of a medical management system, constructed and operative in accordance with an embodiment of the present invention;

FIG. 2B is a perspective illustration of visor head set of FIG. 2A, being worn;

FIG. 3 is a schematic illustration of a perspective view of a location control unit, constructed and operative in accordance with another embodiment of the present invention.

FIGS. 4A-I are sample screens for display on a visor in accordance with an embodiment of the present invention.

FIG. 5 is a block diagram of processes used in accordance with an embodiment of the present invention.

FIG. 6 is a representation of a screen presented to an agent in accordance with an embodiment of the present invention wherein Help is offered in the upper right corner.

FIG. 7 is a representation of a screen presented to an agent in accordance with an embodiment of the present invention wherein available Keywords are listed in the upper right corner.

### DETAILED DESCRIPTION OF SPECIFIC EMBODIMENTS

Definitions. As used in this description and the accompanying claims, the following terms shall have the meanings indicated, unless the context otherwise requires:

An “agent” as used herein is a natural person wearing a portable controller including a headset for participation in a workflow management system in accordance with an embodiment of the present invention.

A “subject” as used herein is a natural person or a thing being acted upon by an agent in accordance with a workflow from a workflow management system in accordance with an embodiment of the present invention. A “subject” also includes computer software and equipment of any kind, including an aircraft, a computer system, industrial machinery, an appliance, a motor vehicle, a ship, and military equipment.

A described “process” is the performance of a described function in a computer using computer hardware (such as a processor, field-programmable gate array or other electronic combinatorial logic, or similar device), which may be operating under control of software or firmware or a combination of any of these or operating outside control of any of the foregoing. All or part of the described function may be performed by active or passive electronic components, such as transistors or resistors. In using the term “process” we do not necessarily require a schedulable entity, although, in some embodiments, a process may be implemented by such a schedulable entity. Furthermore, unless the context otherwise requires, a “process” may be implemented using more than one processor or more than one (single- or multi-processor) computer.

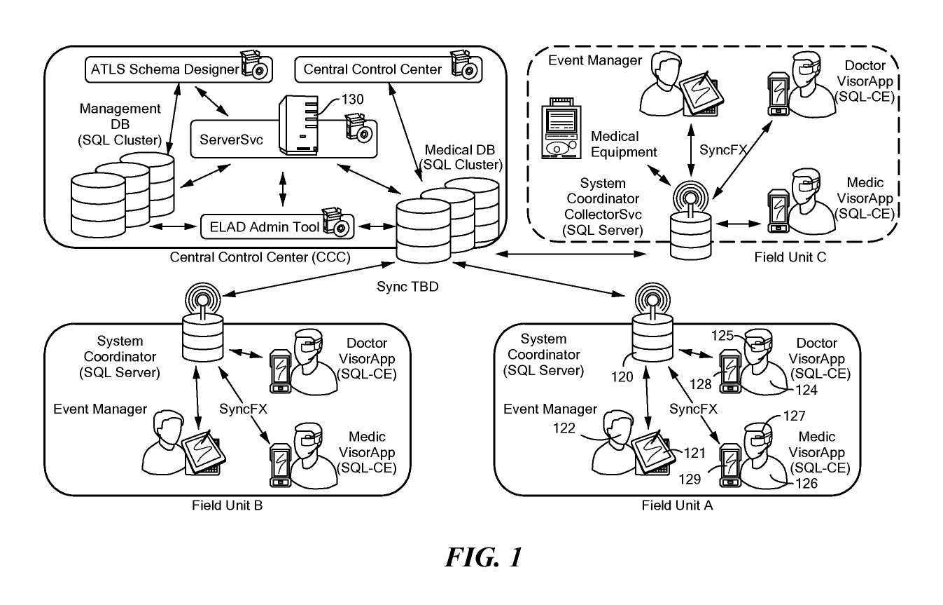

Referring now to FIG. 1, a system coordinator platform is in wireless communication with a plurality of portable controllers. A system coordinator may be provided on a mini server for deployment in the field. It serves as an access point for WiFi/WiMax communication. In an embodiment of the invention, each portable controller may include a headset having a display and a microphone worn by an agent. An event manager has a location control unit 121 that is also in communication with the system coordinator platform for controlling the activities of the agents with the portable controllers. The event manager can view a log of the activities at each of the portable controllers. Thus, the event manager is well positioned in real time to make decisions with respect to the subjects being addressed by the agents. For example, the event manager can move resources toward or away from individual subjects depending on the criticality of needs. To the extent that the system is used to treat humans, the event manager can triage the care based on the displayed real time information. The agents may encompass medical personnel at one of a number of particular battlefields or field hospitals, or in an operating room or emergency room of a hospital or hospital network, mechanics on one of a number of an army or aircraft bases, or at a civilian airport facility, aid workers across a disaster area, and technicians servicing large items of equipment in the field. Thus, there may be a number of system coordinators handling different areas and different pluralities of portable controllers.

A central control center is in communication with each of the system coordinators. The central control center includes a collection of workflow protocols for use by the portable controllers. A workflow designer module allows for the creation of additional workflow protocols to update or expand the capabilities of the system. Different workflow protocols may be developed and provided for a learning scheme, for agents having access to different tools and equipment and for agents with different skills or training. For example, a workflow protocol for taking a doctor through a medical treatment may differ from ones for a paramedic or a medic. Likewise, workflow protocols taking a master electrician through an electrical installation may differ from one for an apprentice. Systems of this type may be used with protocols for a wide variety of service providers including mechanics, plumbers, technicians, detectives, etc.

A workflow protocol includes a logical tree structure that contains major nodes at the root of a complicated tree of flows. Along the tree are decision nodes or junctions. Some of the decision nodes might be multiple decision nodes permitting the agent to select from a multiplicity of choices set forth in a query. A checklist/test set node on a workflow establishes multiple actions all of which need to be taken or checked. At any given node on the workflow one or more steps is taken. Certain events may be programmed to trigger an interrupt to a workflow. A workflow may be enhanced with control jump points for adjusting the flexibility of the workflow. Each item in the workflow may be configured to be selectable by any one of a number of voice commands Indeed, it may be desirable for a selection to be activated by a voice command in any of a number of languages or dialects. In alternative embodiments, selections may be made by a motion. Such motion may be performed by a hand or foot or even an eye, when the portable controller is equipped with suitable tracking technology. A work flow protocol will thus take an agent through a series of queries that solicit information from the agent at the portable controller. The queries may be presented visually in a display or audibly through a speaker.

All information gathered by the workflow protocols followed by agents on the portable controllers can be automatically reported to and stored at the system coordinator server 120 in communication with any given portable controller. The system coordinator server 120 can make the information available to the server 130 at the central control center. Synchronization of the data between the system coordinators and the central control center server 130 can take place regularly or as time is available. In accordance with a presently preferred embodiment, Microsoft Sync Framework is the software employed to synchronize data in real time with the central control center and the portable controllers. Once shared centrally, such information is thus accessible to the system coordinators for sharing as needed with the agents in the fields on their portable controllers and the event managers.

As also shown in FIG. 1, the system coordinator may be used to receive information directly from equipment. For example, medical equipment can be connected by cables or wires or may communicate wirelessly with the system coordinator. Data received from equipment is entered in association with the respective subject to which the equipment is coupled. Such data can then be uploaded to the subject's data on file with the central control center.

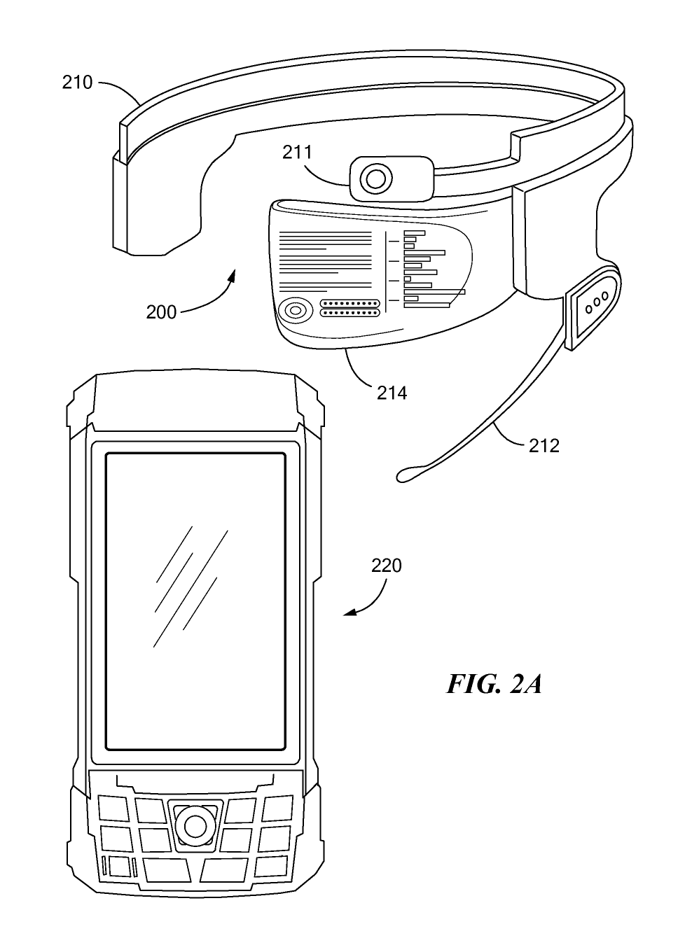

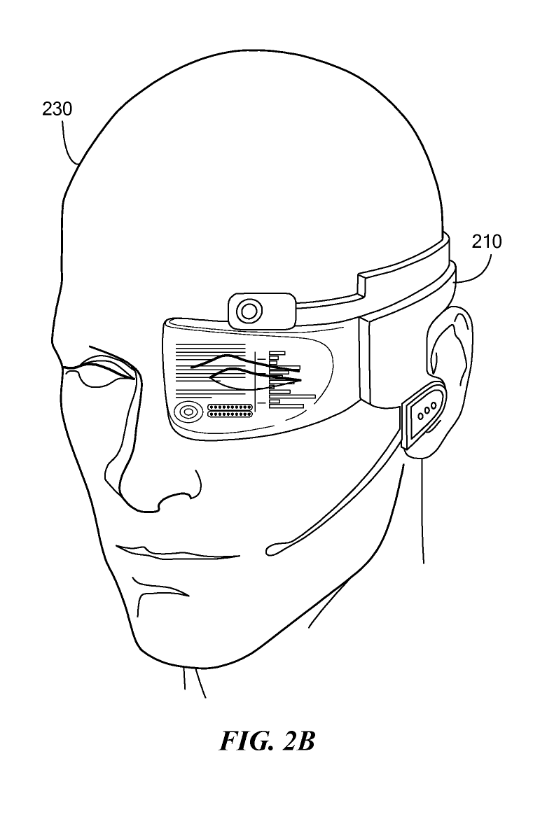

Reference is now made to FIG. 2A, which is a perspective illustration of a portable controller in the form of a visor 200. Visor 200 includes a headset 210 and controller 220. (We sometimes call the controller 220 the “core device” 220.) Headset 210 includes a microphone 212 and a visor OSD (On Screen Display) 214. Any suitable headset with on-screen display may be used. As one example, the visor manufactured and sold by Lumus, Ltd. of Rehovot, Israel has been shown to work well. In addition to or instead of the on screen display, information and queries may be displayed on any portable wireless device, including but not limited to a laptop, phone, smart phone or tablet. The headset may also include a camera sensor 211 and may also include an earphone. Microphone 212, in selected embodiments, is a noise filtering microphone, designed to work in extremely loud environments as well as quiet environments, and is designed and manufactured using materials that make it extremely rugged and durable. In other embodiments, the headset may include motion tracking sensors for detecting hand gestures or eye movements. In still further embodiments, inputs can be made through a wireless mouse, trackball or keyboard.

Controller 220 is a mobile device and includes a powerful processor (not shown), which is able to perform many complicated tasks including true voice recognition, security and encryption, communication with system coordinator server 120 (FIG. 1), decision making algorithms, display instructions to visor OSD 214, and the like. Controller 220 may be a rugged mobile computer for field operation. Various embodiments may include a touch screen, WiFi and cellular network drive and a GPS receiver. One specific embodiment may contain an Intel Atom Z530 processor and 2 GB of RAM. Headset 210 is connected to core device 220 using a reinforced cord (not shown). Controller 220 is kept in a hardened case and can be attached to a belt or vest. A radiation shield can be installed between core device 220 and the body of the agent wearing the headset. Controller 220 has an internal and external battery, and the external battery can be replaced easily without interrupting the work flow of core device 220. The internal battery lasts for 4 to 8 hours and the external battery lasts for 8 to 16 hours. The work time of core device 220 ranges between 12 and 24 hours. Headset 210 will issue an alert before the external battery runs out.

Visor 200, through the co-operation between microphone 212 and controller 220 achieves a microphone and speech recognition of 99% speech recognition reliability, which is superior to the human ear. In order to enhance speech recognition reliability and correct analysis of the audio input of the agent, a restricted vocabulary including a list of predefined allowed terms associated with the situations in which the headset will be used is implemented. To refine recognition even further, each query may have a restricted word set associated with it. It has been found that recognition can be further improved in the speech recognition module by treating some words as background noise. Words found in a restricted word set for a query other than the pending query are treated as background noise. Also, common words not found in the restricted word set for a given query are treated as background noise. Given the limited vocabulary and elimination of non-responsive words that have a relatively high likelihood of being detected, extraordinarily high recognition is possible even for untrained speech recognition. Controller 220 interprets the received speech and then automatically communicates the information in real time to the core transponder at that location, which in turn synchronizes the information with the central control center and the system coordinator (as described in connection with FIG. 1).

It may be desirable to expand a word set so that a selection can be activated by a voice command in any of a number of languages or dialects. In order to provide voice recognition in a variety of languages and be able to add languages to the system, it is advantageous to provide a speech recognition engine that supports the International Phonetic Alphabet. This facilitates adding words from additional languages to the word sets.

In select embodiments, security measures may be taken with the headset. For example, in order to be able to start using headset 210, each agent has to issue a voice print identification, which authenticates the agent to use the particular headset 210, if the voice print is recognized Each agent may be associated with a profile which includes his skill set and expertise, type of treatments or actions that he is allowed to deliver, and the like. This is an important security measure intended to protect subjects from phony service providers who may have ill-intensions.

Work flow screens are advantageously presented in an on-screen display to the agent. The visual screen allows the agent to see information and queries on the screen. Thus, the agent can avoid major interruptions to the work being performed. The agent's hands remain free to work while the screens are displayed on-screen and the agent responds verbally. Visor OSD 214 is made using transparent electroluminescent technology and is optically translucent. It has a wide viewing angle of greater than 160°, and has a rapid display response time of less than 1 ps. It can be configured to be used in a wide variety of environments, from a dark environment to a very bright one due to its large range of configurable brightness and contrast. In order to protect the agent, the visor OSD is designed such that it has very low EMI (electro-magnetic interference) emissions. Additionally, because the visor OSD 214 is intended to be used in chaotic crisis environments that can be unpredictable, the visor has a design and is manufactured using durable materials making it rugged, durable, reliable, comfortable to wear, and have a long operating life.

The work flow system in embodiments described herein efficiently delivers services to numerous subjects, each of which is being served by an agent with a portable controller. The subjects may be people such as soldiers or things such as for example, motor vehicles, aircraft or equipment. In maintaining a useful database, it is useful to provide each subject with a unique identifier. The identifier may be in the form of a number or code. The identifier may advantageously be integrated with the subject. Any number of available identification mechanisms may be used such as barcodes, RFID tags, a UV light readable stamp, etc. For people, identification may additionally or alternatively be in the form of a retinal scan, face recognition, fingerprint identification, genetic matching or the like. The camera sensor 211 on the headset 210 may be used in identifying a subject. Of course, additional identification readers may be included on the headset 210 or the core device 220. For example, an RFID reader, fingerprint reader or UV light source may be added to the headset.

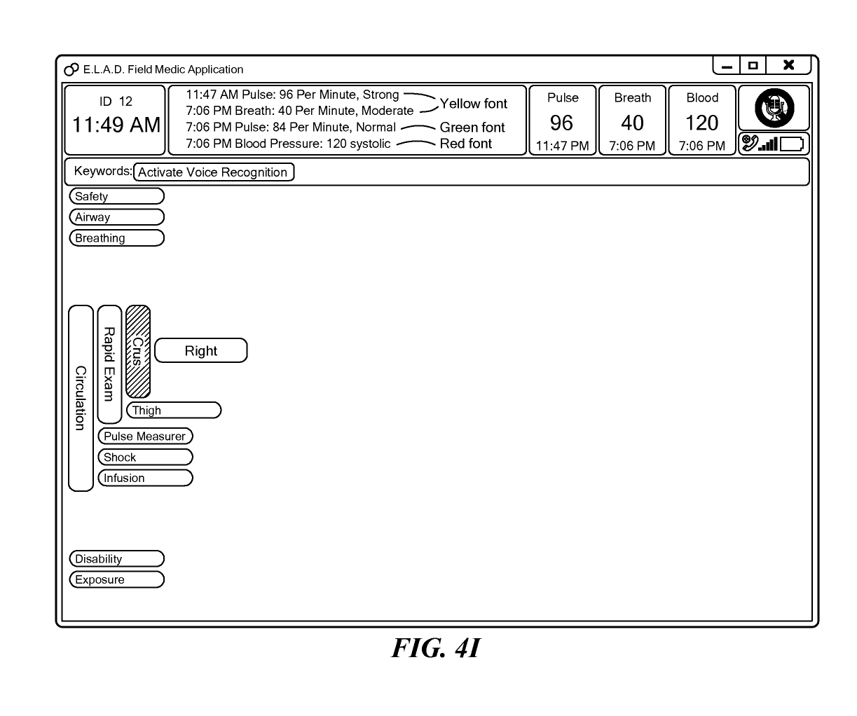

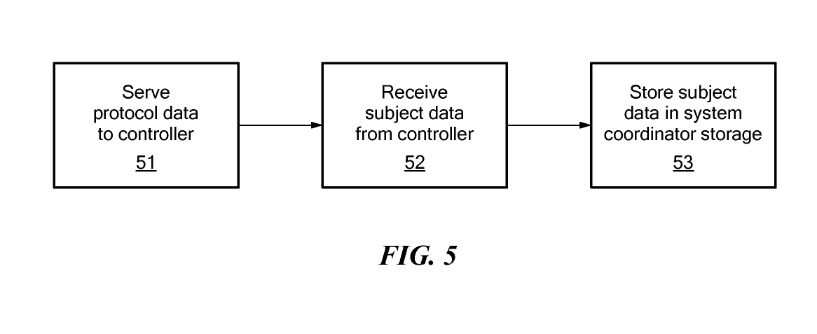

FIG. 5 is a block diagram of a method performed by the system of FIG. 1 in accordance with an embodiment of the present invention. For use of a visor 200 in the field, in process 51, wireless serving of protocol data is performed by a system coordinator server 120 to the core device 220 of the visor 200. Protocol data includes a logical tree structure for a series of queries configured to implement the protocol presented by the core device 220 to the On Screen Display (OSD) 214 associated with visor 200. Queries can be visually presented on the OSD or they may be audibly presented through a speaker on the headset. The screens can be used to guide the agent through data collection, diagnosis and an action plan with respect to a given subject. A screen may present one or more queries. A workflow can be implemented through a series of screens directed by the agent through the tree structure. The agent may respond to queries on the visor OSD 214 with voice responses spoken into the microphone. These responses relate to the subject and thus constitute subject data. In process 52, receiving of the subject data from the core device 220 by the system coordinator server 120 is accomplished in one of a number of ways. For example, the speech may be directly stored in the core device 220 until it can be transmitted to the system coordinator server 120. Speech recognition can take place in the system coordinator server after receiving the subject data. Alternatively, the speech may be passed through speech recognition locally in the core device 220 and stored as recognized speech in the form of text or code until it is transmitted to the system coordinator server 120. In a still further embodiment, the speech may be transmitted to the system coordinator server 120 in real time over the network. After receiving the subject data in the form of speech, speech recognition can be performed at the system coordinator server 120. Once the subject matter received by the system coordinator server is in a desired format, then, in process 53, storing of the subject matter is performed in system coordinator storage at the system coordinator server 120 for further dissemination.

The disclosed technique as generally described above may be applied in particular to a medical environment. The technique may be applied to provide a medical information management and coordination system and method for use, particularly but not limited to during emergencies in the field, as well as in a clinic or hospital environment. The system and method of the disclosed technique assigns a unique identifier to each casualty and enables medical providers to efficiently record information about each casualty. This information is accessible to an event manager at the emergency location, and is also transmitted to a centralized control station for storage and synchronization. The event manager co-ordinates which casualties receive priority treatment based on severity of injury, co-ordinates which medical providers are best suited to provide care to which casualties, including instructing medical personnel on-site in real-time, and co-ordinates efficient transition of casualties from the emergency location to other medical locations. Medical information about the casualties is automatically sent to the other medical location prior to, or along with the arrival of the casualties.

Referring again to FIG. 1, a workflow system in accordance with an embodiment of the present invention is here particularly arranged to operate as a medical management system. The medical management system comprises emergency field location A, second field location B, and central control center. Emergency field location A is a site at, or near to where some event has occurred resulting in a medical crisis where a large number of casualties/patients (not shown) are the subjects who need to be treated simultaneously and immediately. At emergency field location A there is included a location control unit 121 used by an event manager 122. Medical providers 124 (here a doctor) and 126 (here a medic) acting as the agents wear visors 125 and 127, respectively, in turn coupled respectively to controllers 128 and 129 (worn by the agents 124 and 126 respectively) that communicate wirelessly with the system coordinator server 120. In turn, the system coordinator server 120 is in communication with a central server 130 at the central control center. The event manager 122 supervises the medical providers 124 and 126 and accesses data from the system coordinator server 120 via location control unit 121 to assist in doing so. The location control unit 121 may be a wireless tablet computer. Numerous technologies known in the art may be used for wireless communication with the system coordinator server including, for example 1024 IPSEC tunnel Wi-Fi, Bluetooth, infrared and fiber optic. Each visor 125, 127 has its own unique certificate that can be revoked at any time by central control server 130, thus rendering the revoked visor dysfunctional.

Upon arriving to a medical field location A (or casualties arrive to an emergency field environment A), medical providers 124 and 126 immediately get to work attending to the casualties (not shown) appearing in the most urgent need of treatment, unless event manager 122 has already assessed the situation and provides prioritized co-ordination instructions. Each casualty (sometimes herein called a “subject”) is tagged with a unique identifier which is either affixed to the casualty, or printed/stamped onto the casualty, for example with the use or a barcode bracelet or RFID bracelet, or other quick identification method known in the art. Alternatively, still or video images of the patient and/or the casualty or injury or a whole treatment session are taken through an adequate camera sensor mounted on visor 200 and depicted as item 211 in FIG. 2A, which are stored and forwarded as part of the subject information uniquely related to the patient. These images can be added to a general database that can be used to facilitate identification of a patient or the casualty or injury, by comparison to stored images, if no other identification means are used or operable. As medical provider 124 treats a casualty, visor 125 collects medical information about this specific casualty being treated and sends the information connected with the casualty's unique identifier to the system coordinator server 120. In turn the system coordinator server 120 sends the information to server 130 of the central control center, for information storage and synchronization. The medical information comprises the casualty's unique identifier, injury diagnosis, treatment and medications provided. Event manager 122 uses information received by his location control unit 121 to send out coordination instructions back out to visors 125 and 127, as well as summarized information to central control center server 130. The coordination instructions include for example, prioritizing which casualties should be treated first based on initial diagnosis, and assigning specific medical providers to treat specific casualties based on their specialties and respective injuries. Using the summarized information received, a person acting as the controller at the central control center may triage specific casualties to appropriate treatment facilities, for example to field location B, and send the casualty's medical information to the triage locations. The controller may also coordinate which type of event managers, and medical providers should be assigned to which second locations based on their skills, amount of casualties, the type of injuries that the casualties have suffered, proximity of casualties to different second locations, type of facilities at the second locations, and other factors. It is understood that there can be more than just field locations A and B, as well as more than one controller at the central control center managing the triage big picture triage and evacuation decisions.

It is understood that the medical management system and method according to the disclosed technique is implementable in the field after a tragedy causing a medical crisis, and also in a hospital or clinic environment dealing with a large number of casualties. Field location A may be a specific hospital wing or department, or a clinic and second and third field locations B and C respectively (organized and equipped in a manner analogous to Field location A) may be additional departments or wings of the hospital or clinic. In this scenario, medical providers 124 and 126 may be doctors or nurses, and event manager 122 may be a department control individual tracking patients and their records. Event manager 122 can use location control unit 121 to monitor and add event or complicated instructions in real time to medical providers 124 and 126 via their visors 125, 127. If a patient's diagnosis and required treatment are communicated by medical providers 124 or 126 to respective visors, alerts will be issued on local control unit 121 if a patient treatment has been missed. A field location (such as illustrated in Field Unit C of FIG. 1) may be provided with medical equipment that communicates wirelessly to the system coordinator server to provide additional subject data. Central control station server 130 automatically synchronizes information between all systems in the medical facility, using the casualties' (or patients') unique identifiers, thus information is not lost between departments. Additionally, transitioning a patient from one medical provider to another medical provider, and from one department to another is smoother and less error prone than it would be without the use of the system and method of the disclosed technique. Even after a patient has been transitioned to a new department, an alert will be issued to the location control unit 121 for the new department if a treatment for that transitioned patient has been missed. These are just a few of the many examples that synchronizing patients' medical information across departments in a medical facility can enable.

It is further understood that the system and method of the disclosed technique can be used to co-ordinate more than one crisis situation. For example, emergency field location A may be the site of one medical crisis, and second field location B may be the site of another crisis situation. Central control station server 130 coordinates triage and evacuation to different appropriate medical facilities, or even between crisis locations. Additionally it is understood that the system and method of the disclosed technique is scalable to more than two medical crises and medical facilities, or departments within a medical facility. It should be also appreciated that the system and method of the disclosed technique, although intended primarily to cope with crisis situations, can also be used routinely to facilitate regular operation of medical personnel and medical enterprises, such as hospitals at large, or their regular emergency rooms in particular, under normal conditions, by contributing to the good order and efficiency of the medical management, at the expense of scantly compromising the convenience of the medical personnel.

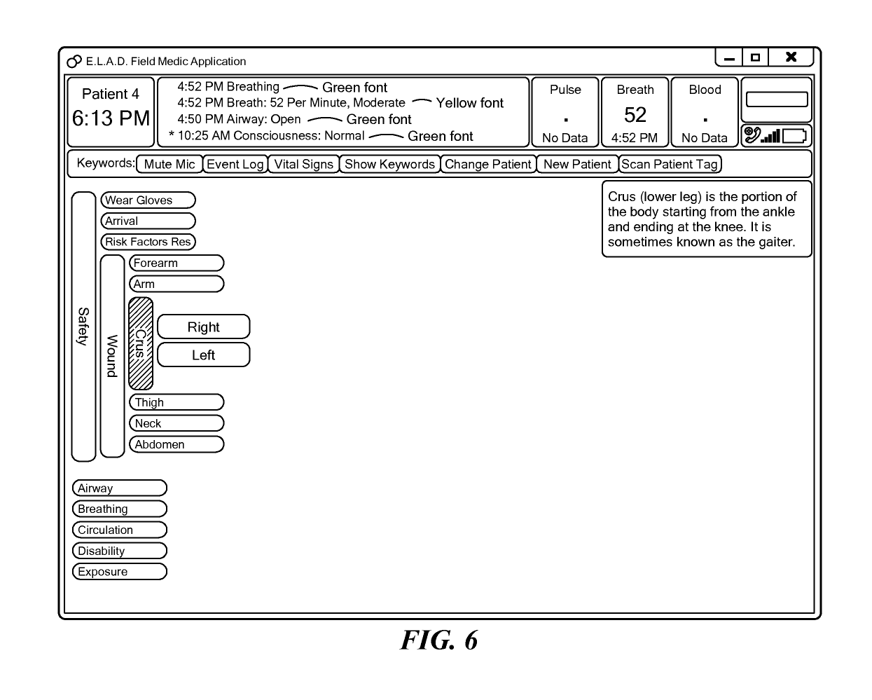

The central control station server 130 is optionally configured in relation to the system coordinator server 120 to provide a barge-in function to a supervisor in chief at the central control center by which any or all agents or any or all event managers (or various subsets and combinations of these) can be contacted in real time. The barge-in function enables passing down instructions aimed at increasing efficiency and responding to circumstances based on strategic considerations that are available to personnel at the central control center. This functionality is achieved by generating appropriate packets at the central control center server that are passed transparently by the system coordinator servers 120 to the designated agents and event managers. For this functionality, the agents and event managers also carry headphones as well as microphones, and real-time full duplex voice communication may occur between the supervisor in chief and the designated agents and event managers, using a technical approach that is the same or similar to that used in voice over IP communications, such as Skype. Similarly, such communication can optionally be initiated by an agent or event manager in an upstream direction to a supervisor in chief. When this kind of communication occurs, a visual notification can be provided to the designated agent or event manager, for example, by using the same area as would be used for a Help screen as discussed below in connection with FIG. 6.

Reference is now made to FIG. 2B, which is a perspective illustration of visor head set 210 of FIG. 2A, being worn. Visor head set 210 is being worn by medical provider 230, which is similar to medical providers 124 and 126. Referring also to FIG. 2A again, visor head set 210 interfaces with medical provider 230.

Upon initial diagnosis, each patient must already have, or be assigned a unique identifier which is somehow affixed, stamped or connected to the patient. Visor 200 may optionally have a scanner component (not shown) which can scan in a barcode from a bracelet, or stamped onto the patient. The unique identifier may be a long lasting stamp only visible under UV light, or an RF/ID tag, or may be another identification method known in the art. Additionally visor 200 may optionally have a face recognition module (not shown) associated with camera sensor 211, that can be used to create, or backup a unique identifier for each patient, as mentioned above. These optional scanner and camera can also be used to document and track other patient information, such as for example a picture or barcode scan of which medication is administered, also for later follow up.

During diagnosis and treatment patient information is dictated by medical provider 230 into microphone 212 (instead of written). Controller 220 uses voice print to detect medical instructions or procedures as they are given in real time. Controller 220 then automatically communicates the patient information in real time to the core transponder at that location, which in turn synchronizes the information with the central control station and the location control unit (as described in FIG. 1).

Visor OSD 214 displays a different screen for each medical provider 230 according to the specific professional needs and can also provide additional info on demand. Information displayed includes patient information, co-ordination and prioritization commands and interrupt assignments sent by the event manager (as described in FIG. 1), treatment guidelines such as A.T.L.S (Advanced Trauma Life Support) and other things. ATLS is a training program for medical providers in the management of acute trauma cases, developed by the American College of Surgeons. ATLS is widely accepted as the standard of care for initial assessment and treatment in trauma centers. The system and method of the disclosed technique has the A.T.L.S. protocol built into its core infrastructure. It guides medical providers 230 by displaying the treatment progress of the patients following the ATLS protocol. As medical provider 230 verbally dictates his progress following ATLS into microphone 212, visor 200 records and updates the ATLS progress and status and communicates it out to medical management system 100 (as described in FIG. 1). Visor OSD 214 displays the current and next step required by the A.T.L.S. scheme to medical provider 230. In this manner, medical provider can move between casualties, knowing their current status in the A.T.L.S. protocol.

In the event that any component of visor 200 are damaged or fail to work, such as core device 220, visor head set 210, or its components microphone 212, visor OSD or other optional components, each component can be easily replaced independently at the crisis location without interfering with the work flow.

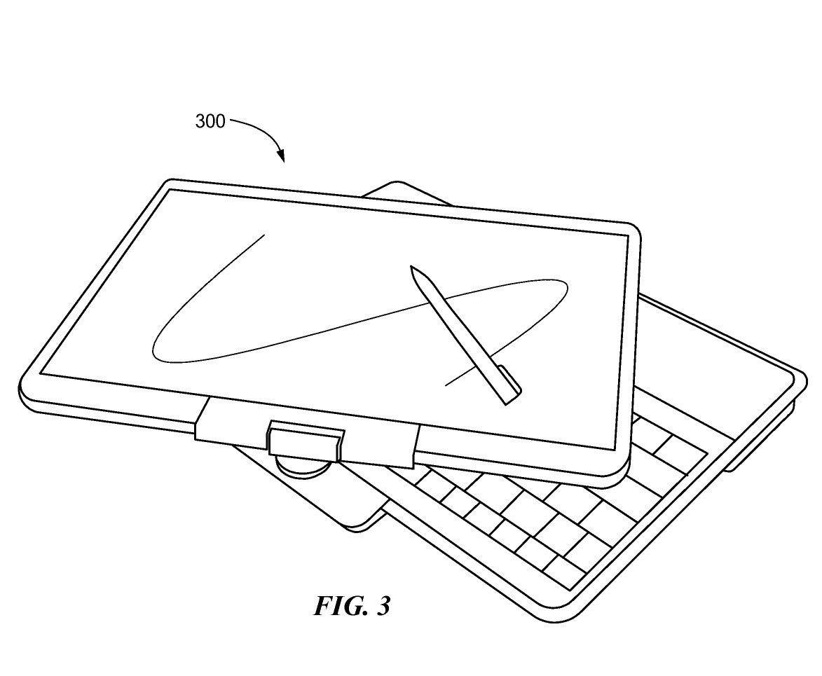

Reference is now made to FIG. 3, which is a schematic illustration of a perspective view of a location control unit, referenced 300, constructed and operative in accordance with another embodiment of the disclosed technique. Location control unit 300 corresponds to location control unit 121, described in connection with FIG. 1. In this embodiment location control unit 300 (121 in FIG. 1) is a field control panel, which is a mobile device and can be held by the event manager.

It is understood that in another embodiment, such as used in a hospital setting, location control unit 300 can be a department control computer, and the event manager can be sitting at a desk coordinating departmental activities, patient flow into and out of a hospital or clinic department and medical providers and their tasks within the department. In this hospital setting, location control unit 300 may issue an alert to visor, or to other medical systems within the hospital environment if a treatment to a patient has been missed. Alternatively, a similar alert can be sent out warning, or notifying that a patient has received a medication or treatment to which he is allergic, or is simply not supposed to receive. For security reasons, an event manager identification authorization is required in order to enable an event manager to start using location control unit 300. Such authentication methods may include event manager entering a password, or issuing a voice print identification. It will be appreciated by persons skilled in the art that the technique is not limited to what has been particularly shown and described hereinabove.

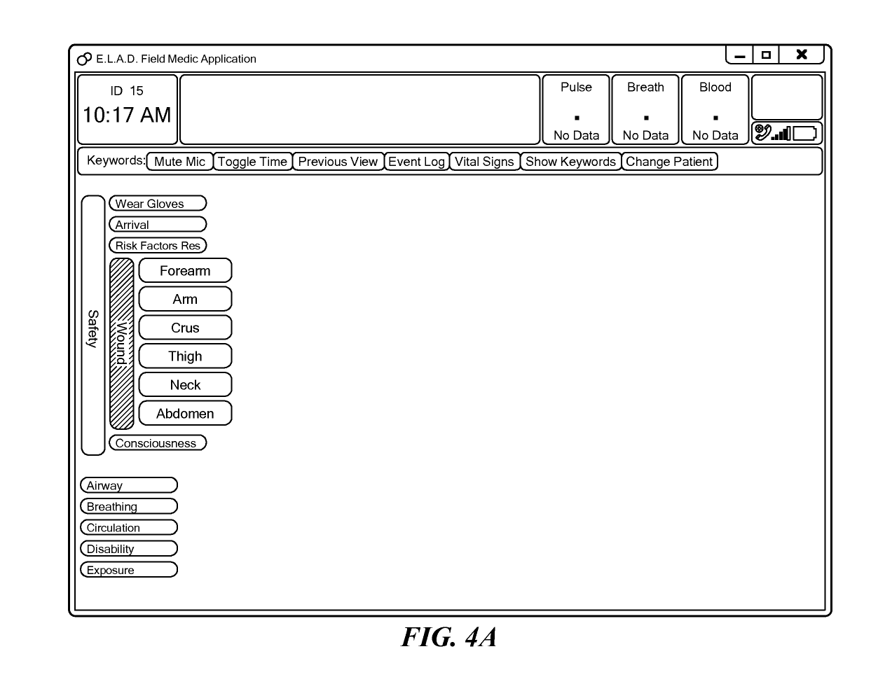

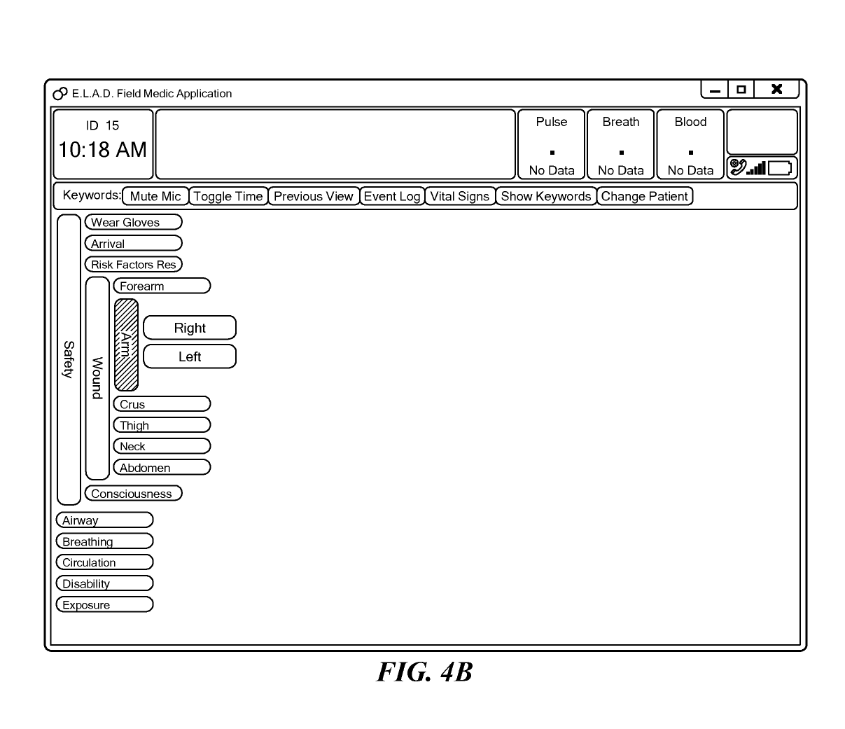

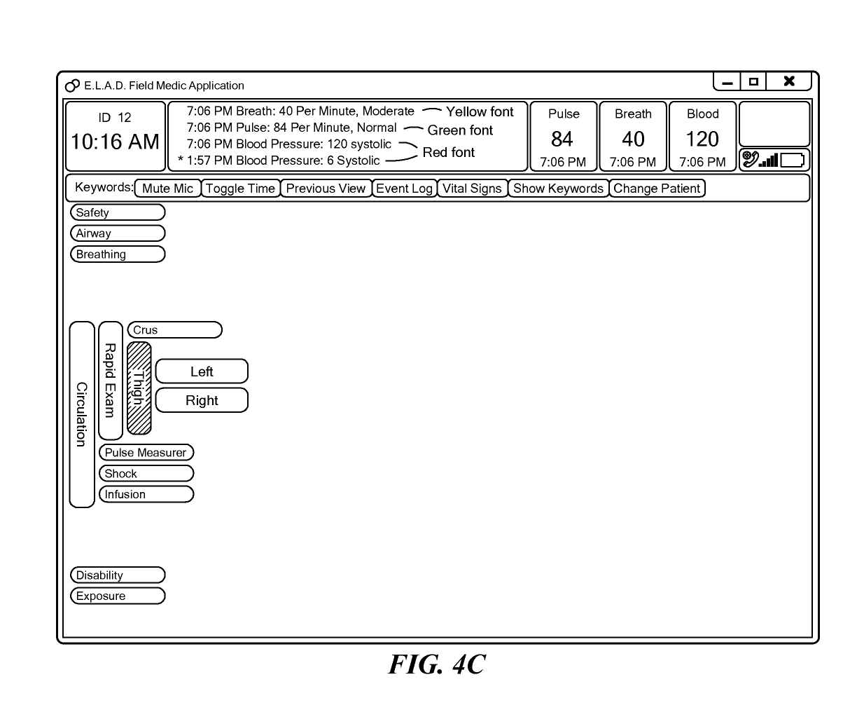

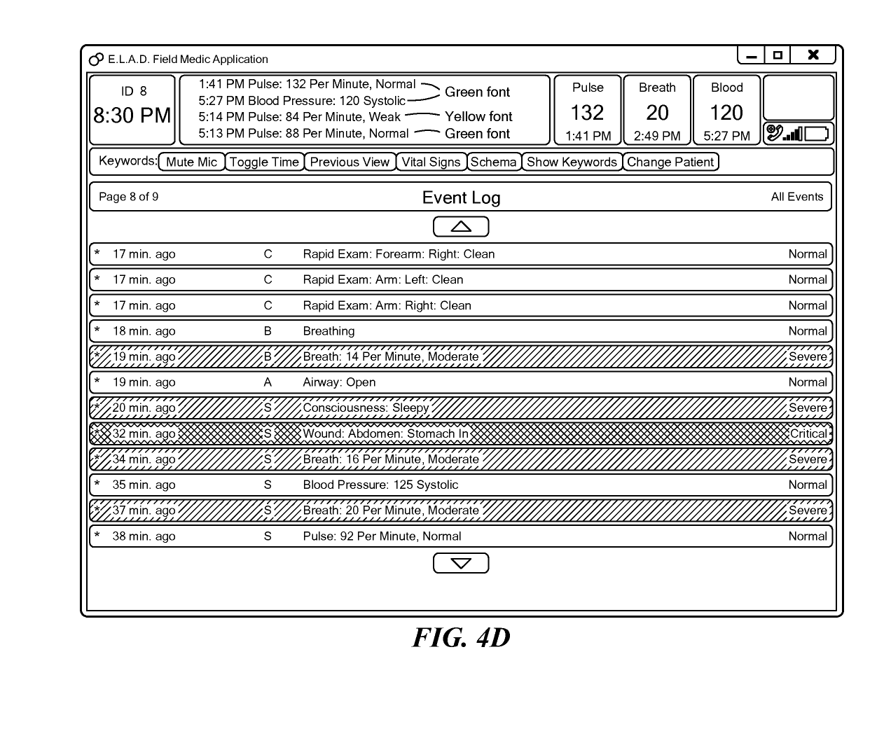

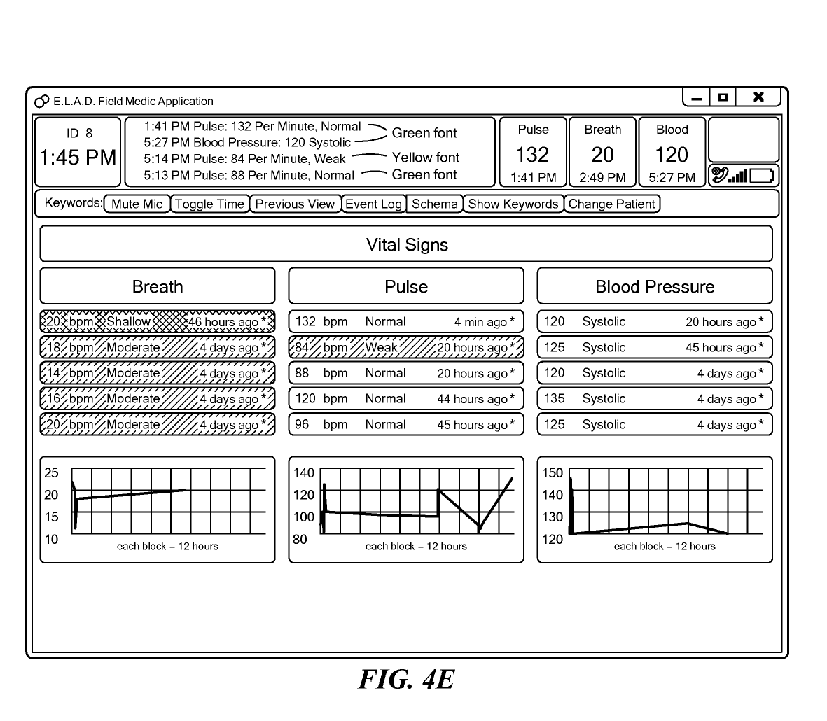

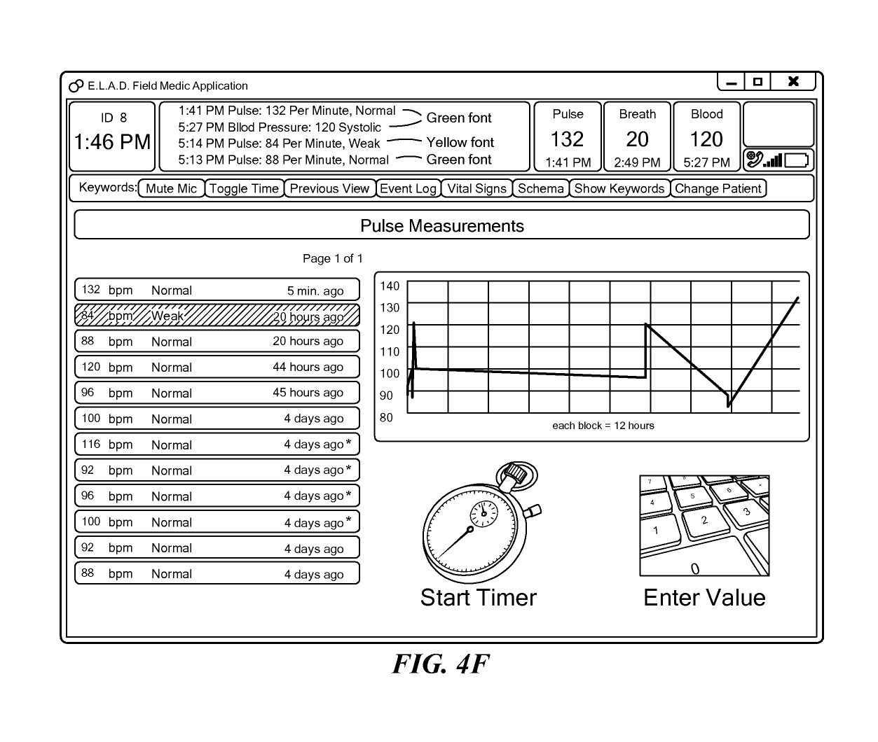

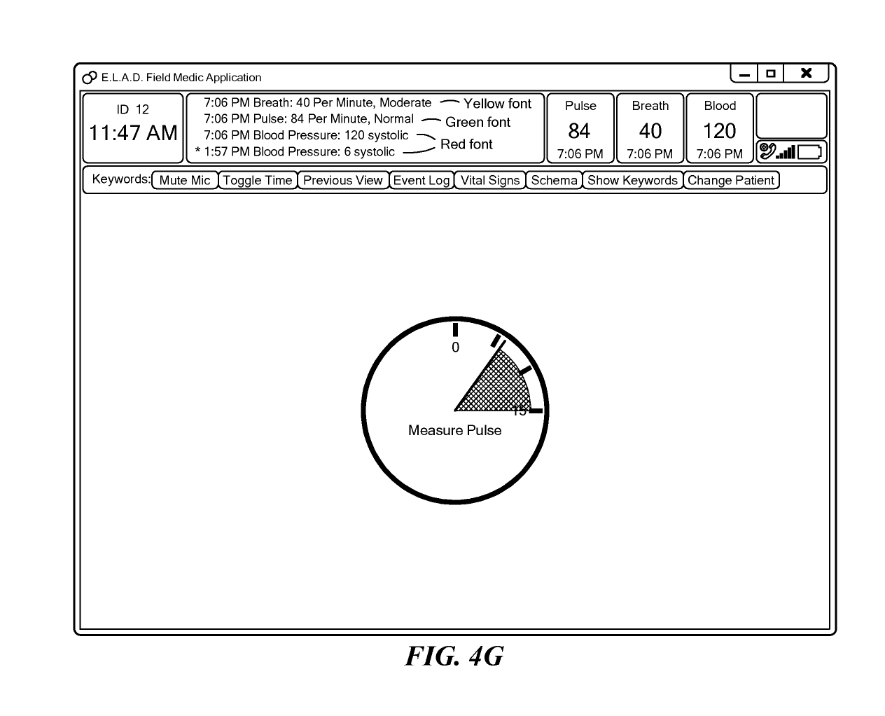

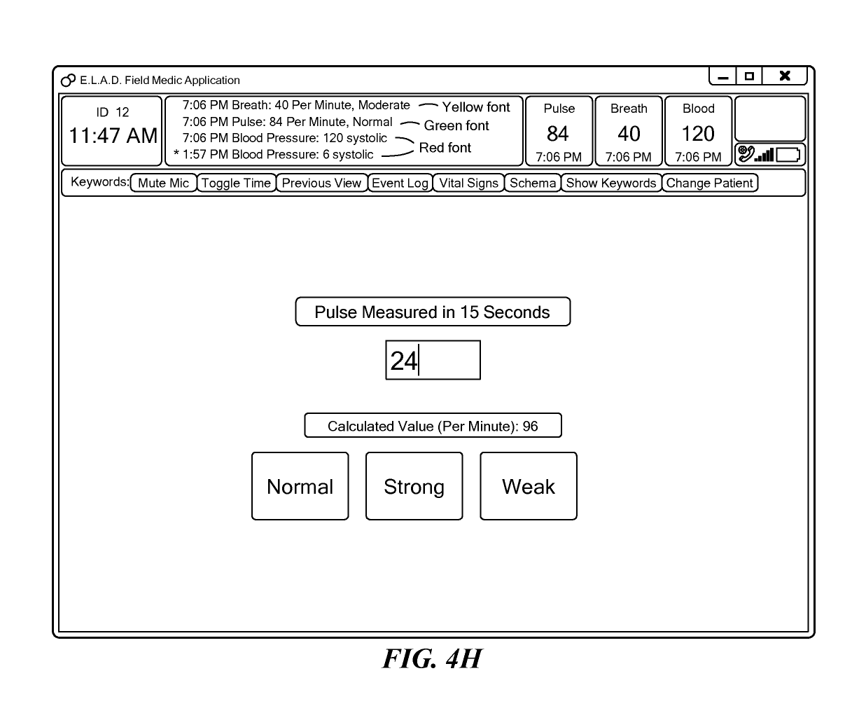

FIGS. 4A-I are sample screens for display on a visor for use by an agent in accordance with an embodiment of the present invention. These screens are used to implement a protocol for treatment of subjects (here, casualties) by a medic acting as the agent as described in connection with FIG. 1. Consequently, FIG. 4A presents a screen by which the agent can enter (using voice commands) wound data for a casualty. The screen shows not only potential locations (on the left) for the wound (such as forearm, arm, crus, etc.) but also “keywords” that can be used to control navigation, screen presentation and other features of the system viewed by the agent. The screen includes a numerical identification number for the subject in the upper left corner as well as a summary of data for vital signs in the upper right.

FIG. 4B shows the effect of a selection by the agent of “arm” in the screen of FIG. 4A, so that the screen now displays a query with choices between “left” and “right” for data entry.

FIG. 4C is similar to the screen shown in FIG. 4B, but here there are also displayed at the top vital signs of the subject as well as a short history of them.

FIG. 4D shows an event log for a subject.

FIG. 4E shows a vital signs screen for a subject wherein details are given of the subject's vital signs, including graphical histories for breath rate, pulse, and blood pressure.

FIG. 4F is a further detailed screen dedicated specifically to pulse, including a chart with detailed history, a graphical history, access to a timer, and a mechanism for entering a current pulse value.

FIG. 4G is the screen displayed when the timer for the pulse measurement is invoked.

FIG. 4H is the screen displayed, after the time screen, for entry of pulse data.

FIG. 4I is a screen for entry of circulation data for the crus region, and it can be seen that the “Activate Voice Recognition” keyword has been invoked and that a microphone with a red background is displayed in the upper right corner of the screen. It should be borne in mind, in connection with screens 4A through 4I that the general mode of data entry is by voice, and that speech recognition in the controller responsive to spoken utterances of the agent converts them into text that is stored as data pertaining to the subject and synchronized with the system coordinator server 120.

FIG. 6 is a representation of a screen presented to an agent in accordance with an embodiment of the present invention wherein Help is offered in the upper right corner.

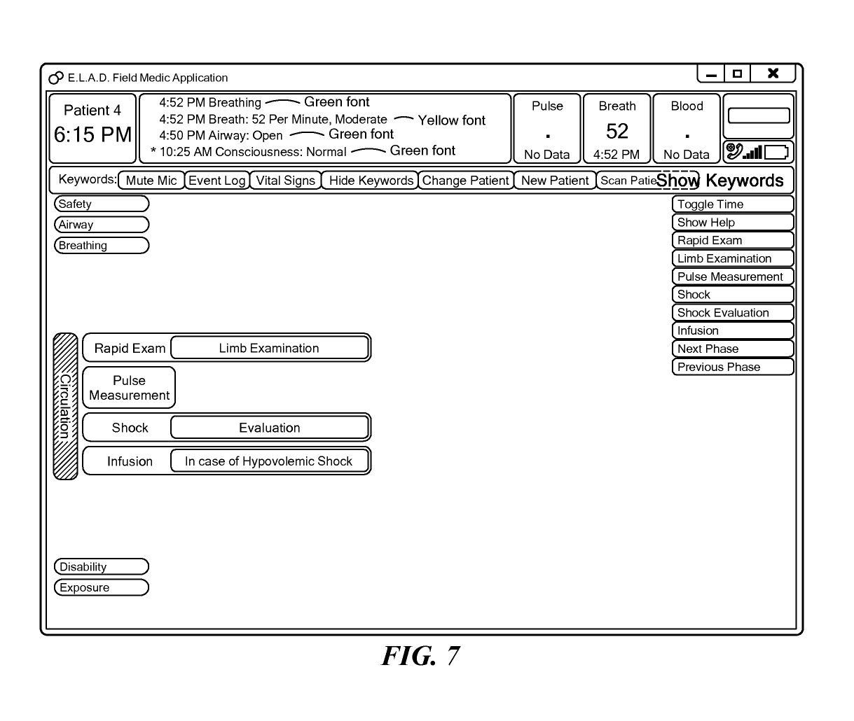

FIG. 7 is a representation of a screen presented to an agent in accordance with an embodiment of the present invention wherein available keywords are listed in the upper right corner. These screens can be invoked by spoken commands of the agent.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A method of administering a work flow protocol, with respect to a subject, carried out by an agent who is a natural person, the method comprising:
wirelessly serving from a system coordinator server, to a portable controller carried by the agent, protocol data characterizing a logical tree structure for a series of queries configured to implement the protocol, wherein the controller is in wireless communication over a network with the system coordinator server and is coupled to a headset worn by the agent, such headset including a display and a microphone, such controller causing presentation of queries through the headset based on the logical tree structure, said presentation including display of screens;
receiving, over the network from the controller, subject data, concerning the subject, that was provided in speech by the agent spoken into the microphone, responsive to the displayed screens; and
storing the subject data in system coordinator storage at the system coordinator server.

2. A method according to claim 1, further comprising synchronizing subject data in the system coordinator storage with subject data that has been stored in a storage device associated locally with the controller.

3. A method according to claim 2, wherein the speech has been recognized by the controller and the recognized speech has been stored as the subject data in the storage device.

4. A method according to claim 2, wherein the speech has been stored prior to recognition as the subject data in the storage device, the method further comprising recognizing the speech in the subject data after it has been received over the network from the controller and thereafter storing the recognized speech in the system coordinator storage.

5. A method according to claim 1, wherein the subject data is received in real time over the network from the controller in the form of speech prior to recognition, the method further comprising recognizing the speech in the subject data after it has been received and thereafter storing the recognized speech in the system coordinator storage.

6. A method according to claim 1, wherein a plurality of the queries have a restricted word set associated therewith to facilitate speech recognition.

7. A method according to claim 6, wherein for a given query, words found in a restricted word set of other of the queries but not in the restricted word set of the given query are treated as background noise during speech recognition.

8. A method according to claim 6, wherein commonly used words not found in the restricted word set of a given query are treated as background noise during speech recognition.

9. A method according to claim 1, wherein the queries comprise at least one audible query announced through the headset.

10. A method according to claim 1, wherein the queries comprise at least one visual query shown on the display of the headset.

11. A method according to claim 1, wherein other controllers are used by other agents and such other controllers are in wireless communication over the network with the system coordinator server, the method further comprising:
making the stored data available over the network, via the system coordinator server, to the other controllers.

12. The method according to claim 1, further comprising:
using information stored in system coordinator storage to update information in a data repository.

13. A method according to claim 11, further comprising:
storing subject data in the system coordinator storage in real time and making such data available in real time to the other controllers.

14. A method according to claim 12, further comprising:
using the subject data in the system coordinator storage to update the repository in real time.

15. A method according to claim 1, wherein the subject is a natural person receiving medical treatment.

16. A method according to claim 1, wherein the subject is at least one of equipment and software being serviced.

17. A method according to claim 1, further comprising providing the subject with a machine readable tag and using the tag for identification of the subject in connection with the subject data.

18. A method according to claim 11, further comprising:
storing subject data in the system coordinator storage in real time, storing data received from the other controllers in the system coordinator storage in real time, and making data in the system coordinator storage available in real time to an event manager controller used by a supervisor of the agents.

19. A method according to claim 12, wherein the repository is in a central control center in communication with a plurality of system coordinator servers and obtaining data from each of the plurality of system coordinator servers.

20. A method according to claim 19, wherein the central control center is in communication with a data center for an enterprise and information from the repository is shared with the data center.

21. A method according to claim 19, wherein the data center stores patient data for one of a hospital and a network of hospitals.

22. A method according to claim 1, wherein the headset includes a camera, coupled to the controller, and configured to capture image data of the subject under control of the agent, the method further comprising receiving image data of the subject over the network from the controller and storing the image data in the system coordinator storage.

23. A method according to claim 1, further comprising receiving, over the network from a peripheral interface coupled to a measurement device in turn trained on the subject, quantitative measurement data concerning a parameter of the subject and storing the measurement data in the system coordinator storage.

24. A method according to claim 1, further comprising receiving data packets corresponding to a barge-in communication from a supervisor in chief at the central control center and forwarding such data packets to the controller for presentation as a barge-in communication to the agent.

25. A method according to claim 24, wherein the packets include digitized voice data for being converted to audio by the controller and an earphone, worn by the agent, coupled to the controller.

26. A method according to claim 25, further comprising passing data packets bi-directionally to facilitate two-way audio communication between the agent and the supervisor in chief.

27. A system for administering a work flow protocol, with respect to a subject, carried out by an agent who is a natural person, the system including a system coordinator server performing computer processes including:
wirelessly serving, to a portable controller carried by the agent, protocol data characterizing a logical tree structure for a series of queries configured to implement the protocol, wherein the controller is in wireless communication over a network with the system coordinator server and is coupled to a headset worn by the agent, such headset including a display and a microphone, such controller causing presentation of queries through the headset based on the logical tree structure, said presentation including display of screens;
receiving, over the network from the controller, subject data, concerning the subject, that was provided in speech by the agent spoken into the microphone, responsive to the displayed screens; and
storing the subject data in system coordinator storage at the system coordinator server.

28. A system according to claim 27, wherein the computer processes further comprise:
synchronizing subject data in the system coordinator storage with subject data that has been stored in a storage device associated locally with the controller.

29. A system according to claim 28, wherein the controller includes a speech recognition module for storing recognized speech as the subject data in the storage device.

30. A system according to claim 28, wherein the speech has been stored prior to recognition as the subject data in the storage device, and wherein the computer processes further comprise recognizing the speech in the subject data after it has been received over the network from the controller and thereafter storing the recognized speech in the system coordinator storage.

31. A system according to claim 27, wherein the subject data is received in real time over the network from the controller in the form of speech prior to recognition, and wherein the computer processes further comprise recognizing the speech in the subject data after it has been received and thereafter storing the recognized speech in the system coordinator storage.

32. A system according to claim 27, wherein a plurality of the queries have a restricted word set associated therewith to facilitate speech recognition.

33. A system according to claim 32, wherein for a given query, words found in a restricted word set of other of the queries but not in the restricted word set of the given query are treated as background noise during speech recognition.

34. A system according to claim 32, wherein commonly used words not found in the restricted word set of a given query are treated as background noise during speech recognition.

35. A system according to claim 27, wherein the queries comprise at least one audible query announced through the headset.

36. A system according to claim 27, wherein the queries comprise at least one visual query shown on the display of the headset.

37. A system according to claim 27, wherein other controllers are used by other agents and such other controllers are in wireless communication over the network with the system coordinator server, and wherein the computer processes further comprise:
making the stored data available over the network, via the system coordinator server, to the other controllers.

38. A system according to claim 27, wherein the computer processes further comprise:
using information stored in system coordinator storage to update information in a data repository.

39. A system according to claim 37, wherein the computer processes further comprise:
storing subject data in the system coordinator storage in real time and making such data available in real time to the other controllers.

40. A system according to claim 38, wherein the computer processes further comprise:
using the subject data in the system coordinator storage to update the repository in real time.

41. A system according to claim 27, wherein the subject is a natural person receiving medical treatment.

42. A system according to claim 27, wherein the subject is a device being field-serviced.

43. A system according to claim 27, wherein the computer processes further comprise providing the subject with a machine readable tag and using the tag for identification of the subject in connection with the subject data.

44. A system according to claim 37, wherein the computer processes further comprise:
storing subject data in the system coordinator storage in real time, storing data received from the other controllers in the system coordinator storage in real time, and making data in the system coordinator storage available in real time to an event manager controller used by a supervisor of the agents.

45. A system according to claim 38, wherein the repository is in a central control center in communication with a plurality of system coordinator servers and obtaining data from each of the plurality of system coordinator servers.

46. A system according to claim 45, wherein the central control center is in communication with a data center for an enterprise and information from the repository is shared with the data center.

47. A system according to claim 45, wherein the data center stores patient data for one of a hospital and a network of hospitals.

48. A system according to claim 27, wherein the headset includes a camera, coupled to the controller, and configured to capture image data of the subject under control of the agent, and wherein the computer processes further comprise receiving image data of the subject over the network from the controller and storing the image data in the system coordinator storage.

49. A system according to claim 27, wherein the computer processes further comprise receiving, over the network from a peripheral interface coupled to a measurement device in turn trained on the subject, quantitative measurement data concerning a parameter of the subject and storing the measurement data in the system coordinator storage.

50. A system according to claim 27, wherein the computer processes further comprise receiving data packets corresponding to a barge-in communication from a supervisor in chief at the central control center and forwarding such data packets to the controller for presentation as a barge-in communication to the agent.

51. A system according to claim 50, wherein the packets include digitized voice data for being converted to audio by the controller and an earphone, worn by the agent, coupled to the controller.

52. A system according to claim 51, wherein the computer processes further comprise passing data packets bi-directionally to facilitate two-way audio communication between the agent and the supervisor in chief.
